(19) United States
(12) Patent Application Publication
(10) Pub. No.: US 2018/0041747 A1
(43) Pub. Date: Feb. 8, 2018

(54) APPARATUS AND METHOD FOR PROCESSING IMAGE PAIR OBTAINED FROM STEREO CAMERA

(71) Applicant: SAMSUNG ELECTRONICS CO., LTD., Suwon-si (KR)

(72) Inventors: Mingcai ZHOU, Beijing (CN); Zhihua LIU, Beijing (CN); Chun WANG, Beijing (CN); Hyun Sung CHANG, Seoul (KR); JINGU HEO, Yongin-si (KR); Lin Ma, Beijing (CN); Tao HONG, Beijing (CN); Weiheng LIU, Beijing (CN); Weiming LI, Beijing (CN); Zairan WANG, Beijing (CN)

(73) Assignee: SAMSUNG ELECTRONICS CO., LTD., Suwon-si (KR)

(21) Appl. No.: 15/668,261

(22) Filed: Aug. 3, 2017

(30) Foreign Application Priority Data
Aug. 3, 2016 (CN) 201610630643.3
Jun. 20, 2017 (KR) 10-2017-0078174

(51) Int. Cl. H04N 13/02; G01C 11/12; G06T 7/593

(52) U.S. Cl. CPC H04N 13/0271; G06T 7/593; H04N 13/0239; G01C 11/12

(57) ABSTRACT

Apparatuses and methods for processing image are provided. The apparatus includes a processor that generates a target region, including the subject, for each of a first frame image and a second frame image, among the plurality of frame images, extracts first feature points in the target region of the first frame image and second feature points in the target region of the second frame image, calculate disparity information by matching the first feature points extracted from the first frame image and the second feature points extracted from the second frame image and determine a distance between the subject and the image capturing device based on the calculated disparity.

### CROSS-REFERENCE TO RELATED APPLICATION

This application claims priority from Chinese Patent Application No. 201610630643.3, filed on Aug. 3, 2016 in the State Intellectual Property Office of the People's Republic of China, and Korean Patent Application No. 10-2017-0078174, filed on Jun. 20, 2017 in the Korean Intellectual Property Office, the disclosures of which are incorporated herein by reference in their entirety.

### BACKGROUND

### 1. Field

Methods and apparatuses consistent with exemplary embodiments relate to an apparatus and method for processing an image pair obtained from a stereo camera.

### 2. Description of the Related Art

A visual sense allows a human to recognize a proximity to an object using information obtained on a surrounding environment through a pair of eyes. For instance, a human brain may determine a distance from a visible object by synthesizing pieces of visual information obtained from the pair of eyes as a single piece of distance information. In related art, a stereo camera system may implement the human visual sense using a machine. The stereo camera system may perform stereo matching on an image pair obtained using two cameras. The stereo camera system may determine a binocular parallax included in an image photographed through stereo matching, and determine a binocular parallax map associated with all pixels or a subject of the image.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an example embodiment, there is provided an image processing method including: generating a target region, including a subject, for each of a first frame image and a second frame image, among an image pair obtained by an image capturing device, extracting first feature points in the target region of the first frame image and second feature points in the target region of the second frame image; determining disparity information by matching the first feature points extracted from the first frame image and the second feature points extracted from the second frame image, and determining a distance between the subject and the image capturing device based on the calculated disparity information.

The determining the disparity information may include: generating a first tree including the first feature points of the first frame image as first nodes by connecting the first feature points of the first frame image based on a horizontal distance, a vertical distance, and a Euclidean distance between the first feature points of the first frame image, generating a second tree including the second feature points of the second frame image as second nodes by connecting the second feature points of the second frame image based on a horizontal distance, a vertical distance, and a Euclidean distance between the second feature points of the second frame image and matching the first nodes of the first tree and the second nodes of the second tree to determine the disparity information of each of the first feature points of the first frame image and each of the second feature points of the second frame image.

The matching may include: accumulating costs for matching the first nodes of the first tree and the second nodes of the second tree along upper nodes of the first nodes of the first tree or lower nodes of the first nodes of the first tree, and determining a disparity of each of the first feature points of the first frame image and each of the second feature points of the second frame image based on the accumulated costs, wherein the costs are determined based on a brightness and a disparity of a node of the first tree and a brightness and a disparity of a node of the second tree to be matched.

The image processing method may further include determining a disparity range associated with the subject based on a brightness difference between the target region of the first frame image and the target region of the second frame image determined based on a position of the target region of the first frame image.

The image processing method may further include calculating of the disparity information comprises matching the first feature points extracted from the first frame image and the second feature points extracted from the second frame image within the determined disparity range.

The determining of the disparity range may include: moving the target region of the second frame image in parallel and comparing a brightness of the target region of the second frame image moved in parallel to a brightness of the target region of the first frame image.

The image processing method may further include extracting a feature value of the target region corresponding to the first frame image, generating a feature value plane of the first frame image based on the extracted feature value, comparing the feature value plane to a feature value plane model generated from a feature value plane of previous frame image obtained previous to the first frame image and determining a position of the subject from the first frame image based on a result of the comparing of the feature value plane to the feature value plane model.

The image processing method may further include changing the feature value plane model based on the determined position of the subject.

The plurality of frame images may include an image pair obtained from a stereo camera photographing the subject.

According to an aspect of another exemplary embodiment, there is provided an image processing apparatus including: a memory configured to store an image pair obtained by an image capturing device; and a processor configured to: generate a target region, including the subject, for each of a first frame image and a second frame image, among the image pair; extract first feature points in the target region of the first frame image and second feature points in the target region of the second frame image, determine disparity information by matching the first feature points extracted from the first frame image and the second feature points extracted from the second frame image and determine a distance between the subject and the image capturing device based on the calculated disparity.

The processor may be further configured to determine the disparity information based on costs for matching a first tree including the first feature points of the first frame image as first nodes and a second tree including the second feature points of the second frame image as second nodes.

The processor may be further configured to determine the costs based on a similarity determined based on a brightness and a disparity of a feature point corresponding to a node of the first tree and a brightness and a disparity of a feature point corresponding to a node of the second tree.

Each of the first tree and the second tree may be generated by connecting the first feature points of the first frame image between which a spatial distance is smallest and the second feature points of the second frame image between which a spatial distance is smallest.

The processor may be further configured to determine a disparity range associated with the subject based on a brightness difference between the target region of the first frame image and the target region of the second frame image determined based on a position of the target region of the first frame image.

The processor may be further configured to match the first feature points extracted from the first frame image and the second feature points extracted from the second frame image within the determined disparity range.

The processor may be further configured to extract a feature value of the target region corresponding to the first frame image, generate a feature value plane of the first frame image based on the extracted feature value, compare the feature value plane to a feature value plane model generated from a feature value plane of a previous frame image obtained previous to the first frame image and determine a position of the subject from the first frame image based on a result of the comparing of the feature value plane to the feature value plane model.

The plurality of frame images may include an image pair obtained from a stereo camera photographing the subject.

According to an aspect of another exemplary embodiment, there is provided a non-transitory computer readable medium having stored thereon a program for executing a method of processing an image pair including: generating a target region, including a subject, for each of a first frame image and a second frame image, among an image pair obtained by an image capturing device; extracting first feature points in the target region of the first frame image and second feature points in the target region of the second frame image, determining disparity information by matching the first feature points extracted from the first frame image and the second feature points extracted from the second frame image and determining a distance between the subject and the image capturing device based on the calculated disparity information.

### BRIEF DESCRIPTION OF THE DRAWINGS

The above and/or other aspects will be more apparent and more readily appreciated by describing certain example embodiments with reference to the accompanying drawings, in which:

FIG. 1 illustrates a structure of an image pair processing apparatus according to an example embodiment;

FIG. 2 illustrates an operation in which an image pair apparatus generates a target region from a frame image and determines a disparity range associated with a subject based on the generated target region according to an example embodiment;

FIG. 3 is a graph illustrating a brightness difference calculated from an example of FIG. 2 by an image pair processing apparatus according to an example embodiment;

FIG. 4 illustrates an operation in which an image pair processing apparatus determines feature points in a target region according to an example embodiment;

FIG. 5 illustrates an operation in which an image pair processing apparatus generates a minimum tree according to an example embodiment;

FIG. 6 illustrates a comparison experiment on absolute intensity differences (AD), Census, and AD+Census.

FIG. 7 is a flowchart illustrating an operation in which an image pair processing apparatus determines a distance between a stereo camera and a subject included in an image pair according to an example embodiment;

FIG. 8 is a flowchart illustrating an operation in which an image pair processing apparatus tracks a position of a subject commonly included in a plurality of image pairs according to an example embodiment; and

FIG. 9 is a graph illustrating a distribution of response values calculated by fitting a feature value plane to a feature value plane model by an image pair processing apparatus according to an example embodiment.

### DETAILED DESCRIPTION

Hereinafter, various example embodiments will be described with reference to the accompanying drawings. It is to be understood that the content described in the present disclosure should be considered as descriptive and not for the purpose of limitation, and therefore various modifications, equivalents, and/or alternatives of the example embodiments are included in the present disclosure.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions may not be described in detail because they would obscure the description with unnecessary detail.

The terminology used herein is for the purpose of describing the example embodiments only and is not intended to be limiting of the disclosure. As used herein, the singular forms “a,” “an,” and “the” are intended to include the plural forms as well, unless the context clearly indicates otherwise. It will be further understood that the terms “include,” “comprise” and/or “have,” when used in this disclosure, specify the presence of stated features, integers, steps, operations, elements, components, or combinations thereof, but do not preclude the presence or addition of one or more other features, integers, steps, operations, elements, components, and/or groups thereof. In addition, the terms such as “unit,” “-er (-or),” and “module” described in the specification refer to an element for performing at least one function or operation, and may be implemented in hardware, software, or the combination of hardware and software.

Terms such as first, second, A, B, (a), (b), and the like may be used herein to describe components. Each of these terminologies is not used to define an essence, order or sequence of a corresponding component but used to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments are described in detail with reference to the accompanying drawings. Like reference numerals in the drawings denote like elements, and a known function or configuration will be omitted herein.

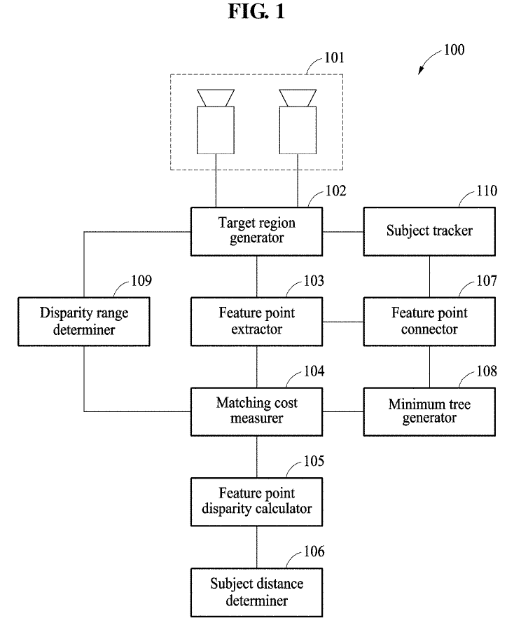

FIG. 1 illustrates a structure of an image pair processing apparatus according to an example embodiment. The image pair processing apparatus is applicable to a vehicle, a robot, a smart wearing equipment, a computer terminal, a mobile terminal or other devices.

Referring to FIG. 1, the image pair processing apparatus 100 includes a stereo camera 101 configured to photograph a subject at different angles for receiving an image pair. For example, the image pair processing apparatus 100 is connected to the stereo camera 101 through a wired network or a wireless network, and receives and stores the image pair obtained by the stereo camera 101.

The stereo camera 101 includes a plurality of image sensors configured to photograph an identical subject. For instance, according to an exemplary embodiment, a plurality of image sensors is configured to photograph the same subject. Two image sensors may be spaced apart from each other by a predetermined distance. Each of the image sensors may generate a frame image by photographing the subject, and the stereo camera 101 may output a pair of frame images (image pair) based on a point in time at which the subject is photographed. Hereinafter, it is assumed that the stereo camera 101 includes a first image sensor and a second image sensor configured to photograph a subject at different angles, similar to eyes of a person. The first image sensor outputs a first frame image and the second image sensor outputs a second frame image by photographing the subject.

Referring to FIG. 1, the image pair processing apparatus 100 includes a target region generator 102 configured to generate a target region including a subject from each of the first frame image and the second frame image of the image pair. The target region generator 102 may generate the target region of the first frame image including a portion including the subject from the first frame image. Similarly, the target region generator 102 may generate the target region of the second frame image including the portion including the subject from the second frame image. A shape of target region may be polygonal or circular, and the shape of target region may be determined based on a shape of a subject.

Referring to FIG. 1, the image pair processing apparatus 100 includes a feature point extractor 103 configured to extract feature points in the target region. The feature point extractor 103 may extract feature points of all frame images of the image pair. The feature points may be selected as pixels in the target region that allow a plurality of frame images to be matched easily. According to an example embodiment, matching of the frame images refers to an operation of processing the frame images to identify a common pixel, a common subject, and a common background in the frame images.

The image pair processing apparatus 100 includes a feature point connector 107 configured to connect the feature points of each of the frame images. The feature point connector 107 may connect the feature points based on a spatial distance between the feature points. The feature point connector 107 may generate a connection graph by connecting the feature points in the target region of each of the frame images.

The image pair processing apparatus 100 includes a matching cost measurer 104 configured to measure costs for matching the feature points of the frame images. The matching cost measurer 104 may measure the costs for matching the feature points using the connection graph generated by the feature point connector 107. The matching cost measurer 104 may accumulate costs measured with respect to each of the feature points based on the connection graph.

In more detail, the image pair processing apparatus 100 includes a minimum tree generator 108 configured to generate a minimum tree from the connection graph. The minimum tree may be generated with respect to each target region of the frame images. The minimum tree may include all feature points in the target region as nodes of the minimum tree. For example, the minimum tree is a minimum cost spanning tree. The matching cost measurer 104 may accumulate the costs measured with respect to each of the feature points based on the minimum tree generated by the minimum tree generator 108. In more detail, the matching cost measurer 104 may determine the costs for matching the feature points corresponding to respective nodes from the minimum tree including all feature points as nodes, and then accumulate the costs determined along a branch, for example, an upper node or a lower node, of the nodes. That is, the matching cost measurer 104 accumulates the costs based on the minimum tree and thus, the minimum tree of which a number of branches is more reduced than the connection graph generated by the feature point connector 107 may be used. Thus, an amount of operation required for accumulating the costs may be reduced.

In an example process in which the matching cost measurer 104 measures the costs for matching the feature points, a disparity range associated with the subject may be used. Referring to FIG. 1, the image pair processing apparatus 100 includes a disparity range determiner 109 configured to determine the disparity range associated with the subject based on a brightness difference between the target regions of the frame images. The disparity range determiner 109 may identify a corresponding region having a height, a shape, and a size identical to those of a target region of a predetermined frame image from the other frame image, and then determine a difference value between a brightness of the target region of the predetermined frame image and a brightness of the corresponding region of the other frame image. The disparity range determiner 109 may determine the disparity range associated with the subject based on a minimum value of the brightness difference. The matching cost measurer 104 may match the feature points based on the determined disparity range. Thus, a speed for measuring the costs for matching the feature points may be enhanced.

The image pair processing apparatus 100 includes a feature point disparity calculator 105 configured to calculate a disparity of each of the feature points based on the accumulated costs. The feature point disparity calculator 105 may determine a disparity for minimizing the accumulated costs as the disparity of each of the feature points. The feature point disparity calculator 105 may determine disparities of all feature points in the target region.

The image pair processing apparatus 100 includes a subject distance determiner 106 configured to determine a distance between the subject and the stereo camera 101 based on the disparity of each of the feature points in the target region. The subject distance determiner 106 may perform an alarm treatment or an operational treatment based on the determined distance between the subject and the stereo camera 101.

The image pair processing apparatus 100 includes a subject tracker 110 configured to track a position of the subject from a plurality of image pairs that are sequentially obtained as time elapses. Whenever an image pair which is newly obtained from the stereo camera 101 is input, the subject tracker 110 may determine the position of the subject in the newly obtained image pair based on a result of the tracking of the subject from a previously input image pair.

A structure of the image pair processing apparatus 100 illustrated in FIG. 1 is only an example. The target region generator 102, the feature point extractor 103, the matching cost measurer 104, the feature point disparity calculator 105, the subject distance determiner 106, the feature point connector 107, the minimum tree generator 108, the disparity range determiner 109, and the subject tracker 110 may be implemented by at least one single-core processor or a multi-core processor. The target region generator 102, the feature point extractor 103, the matching cost measurer 104, the feature point disparity calculator 105, the subject distance determiner 106, the feature point connector 107, the minimum tree generator 108, the disparity range determiner 109, and the subject tracker 110 may be implemented in a combination of at least one processor and memory.

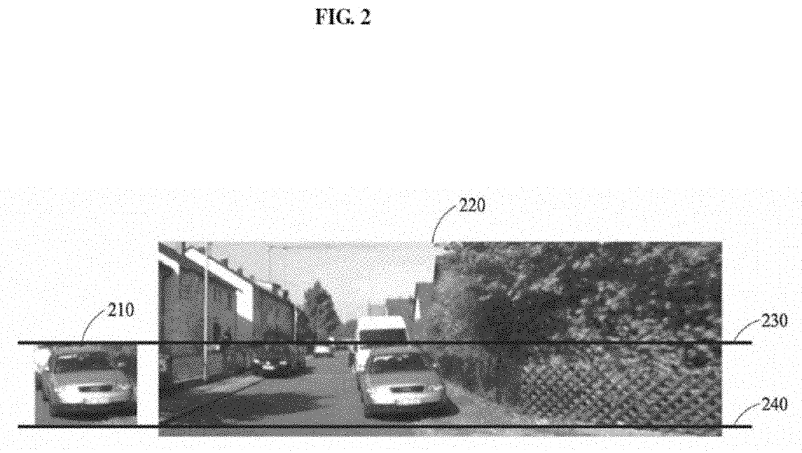

FIG. 2 illustrates an operation in which an image pair apparatus generates a target region 210 from a frame image and determines a disparity range associated with a subject based on the generated target region 210 according to an example embodiment.

A disparity indicates a difference between horizontal coordinates of a subject image included in each of two frame images generated by photographing the identical subject by two image sensors to be horizontally spaced apart from each other by a predetermined distance. The disparity in the image pair obtained from the stereo camera 101 of FIG. 1 indicates a difference between a position of a subject included in a first frame image and a position of the subject included in a second frame image.

When a subject image of the first frame image moves in parallel in a pixel unit, the moved subject image of the first frame image may overlap a subject image of the second frame image because the image pair is a pair of frame images obtained by photographing the identical subject. Referring to FIG. 2, the image pair processing apparatus may perform parallel movement in a unit of the target region 210 being relatively wider than a region of the subject, for example, a vehicle of FIG. 2.

Hereinafter, it is assumed that the image pair processing apparatus generates the target region 210 from the first frame image, for example, a left image obtained from a left camera of a stereo camera. The image pair processing apparatus may determine a region, hereinafter referred to as a corresponding region of the target region 210, of a second frame image 220, for example, a right image obtained from a right camera of the stereo camera, corresponding to the target region 210 based on coordinates of the target region 210 on the first frame image.

The image pair processing apparatus may generate a plurality of corresponding regions by moving the corresponding regions in parallel based on the coordinates of the target region 210. For example, the image pair processing apparatus may generate a corresponding region k by moving a region, in parallel, in the second frame image 220 having a size and coordinates identical to those of the target region 210 in a horizontal direction, for example, a positive direction of an x-axis. Thus, the coordinates of the target region 210 may be different from the coordinates of the corresponding region k by k pixels. Because the target region 210 is set to be a region including the subject, a plurality of corresponding regions may include the subject.

The image pair processing apparatus may determine the disparity range associated with the subject based on a brightness difference between the generated corresponding regions and the target region 210. A difference between a position of the target region 210 and a position of a corresponding region having a minimum brightness difference may be the disparity associated with the subject. The disparity range includes the difference between the target region 210 and the corresponding region having the minimum brightness difference. For example, when a brightness difference between a corresponding region a and the target region 210 corresponds to a minimum value, the disparity range may include a degree a of parallel movement of the corresponding region a based on the position of the target region 210.

Referring to FIG. 2, the image pair processing apparatus may move a corresponding region of the second frame image 220 in parallel along sweep lines 230 and 240. The sweep lines 230 and 240 may be determined as lines parallel to a horizontal axis or an x-axis of the second frame image 220. Vertical coordinates or y-coordinates of the sweep lines 230 and 240 may be determined based on vertical coordinates or y-coordinates of the target region 210 in the first frame image. The image pair processing apparatus may adjust a degree of parallel movement of the corresponding region along the sweep lines 230 and 240 from a zeroth pixel position to a pixel position being less than or equal to a horizontal length of the second frame image 220. For example, the image pair processing apparatus may generate 101 corresponding regions by moving the corresponding regions in parallel along the sweep lines 230 and 240 from the zeroth pixel position to a 100-th pixel position. Alternatively, the image pair processing apparatus may generate 257 corresponding regions by moving the corresponding regions in parallel along the sweep lines 230 and 240 from the zeroth pixel position to a 256-th pixel position.

When the corresponding regions are moved in parallel in a pixel unit based on the position of the target region 210, the disparity range may be determined as an interval of pixels during which the corresponding regions are movable. For example, referring to FIG. 2, a disparity range [0, 100] indicates that a corresponding region moves along the sweep lines 230 and 240 from a zeroth pixel position to a 100-th pixel position based on the position of the target region 210. The image pair processing apparatus may determine the brightness difference between the target region 210 and each of the corresponding regions within the disparity range [0, 100].

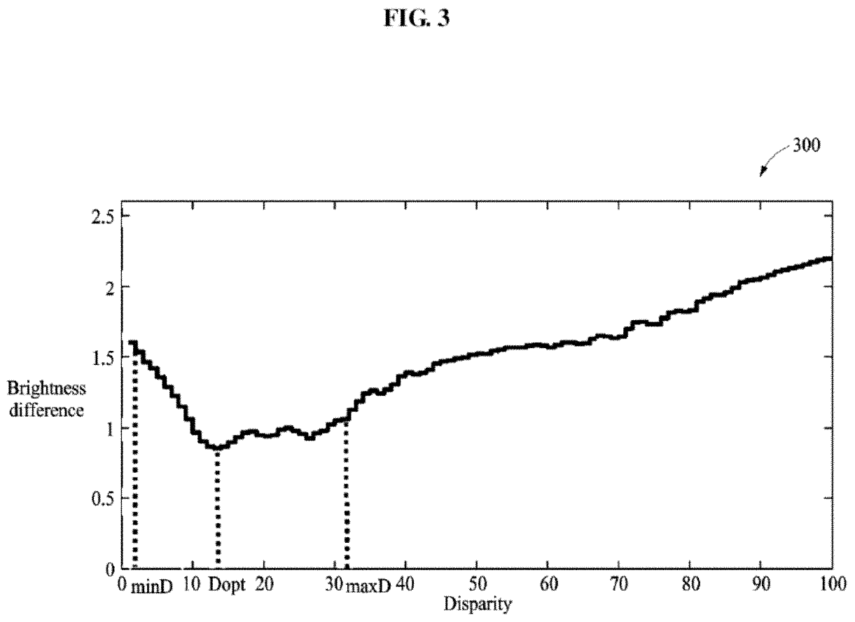

FIG. 3 is a graph 300 illustrating a brightness difference calculated from an example of FIG. 2 by an image pair processing apparatus according to an example embodiment. Referring to FIG. 3, a horizontal axis indicates a disparity, that is, a degree of a parallel movement of a corresponding region based on a position of a target region in a pixel unit. A vertical axis indicates a brightness difference between a corresponding region of a second frame image and a target region of a first frame image. A curved line of the graph 300 may be a parabola that opens upward. The image pair processing apparatus may identify a difference Dopt corresponding to a disparity that minimizes a brightness difference. A portion of the second frame image included in a corresponding region Dopt moved in parallel by Dopt may be matched to the target region better than that of remaining corresponding regions.

The image pair processing apparatus calculates a disparity range [minD, maxD] including Dopt using Equation 1 and Equation 2.

$$\begin{matrix}max D = \{ \begin{matrix}d & if d > Dopt \&\& difference ( d ) > \\ & 1.5 \times difference ( Dopt ) \\ max\_disparity & else\end{matrix} & [ Equation 1 ] \\ min D = \{ \begin{matrix}d & if d < Dopt \&\& difference ( d ) > \\ & 2 \times difference ( Dopt ) \\ 0 & else\end{matrix} & [ Equation 2 ]\end{matrix}$$

In Equations 1 and 2, && denotes an AND conditional operator, and max_disparity denotes a degree to which the image pair processing apparatus maximally moves a corresponding region in parallel. Also, difference (d) denotes a brightness difference between a corresponding region d and a target region. Equations 1 and 2 are only examples. A coefficient or a threshold value to be applied to the brightness difference may be set to be different values. The image pair processing apparatus may determine the brightness difference between the corresponding region and the target region through sampling.

Referring to FIG. 3, the disparity range [minD, maxD] which is finally calculated by the image pair processing apparatus may be less than a range [0, 100] in which the corresponding region moves in parallel for calculating the disparity range [minD, maxD] by the image pair processing apparatus. Because the image pair processing apparatus uses the disparity range [minD, maxD] to obtain a disparity of each of feature points, further, a disparity associated with a subject, or a distance between the subject and the stereo camera, an amount of operation performed by the image pair processing apparatus may be reduced.

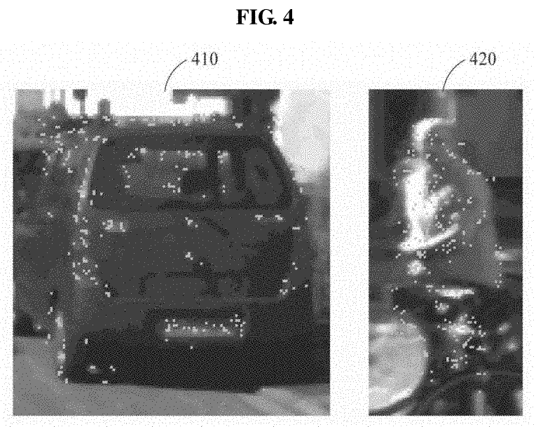

FIG. 4 illustrates an operation in which an image pair processing apparatus determines feature points in a target region according to an example embodiment.

In FIG. 4, feature points extracted from target regions 410 and 420 by the image pair processing apparatus are represented in dots. The image pair processing apparatus may extract the feature points based on an oriented FAST and rotate BRIEF (ORB) method. In addition, the image pair processing apparatus may extract the feature points based on a binary robust invariant scalable keypoints (BRISK) method, an oriented features from accelerated segment test (OFAST) method, or a features from accelerated segment test (FAST) method.

The image pair processing apparatus may calculate a disparity of each of the extracted feature points instead of calculating disparities of all pixels in a target region to determine a distance between a subject and a stereo camera. Thus, an amount of time or an amount of operation used to determine the distance between the subject and the stereo camera by the image pair processing apparatus may be reduced.

The image pair processing apparatus generates a connection graph for each target region of a frame image by connecting the feature points extracted from the target region. The image pair processing apparatus may measure a horizontal distance, a vertical distance, and a Euclidean distance between the feature points and then connect two feature points between which a measured distance is shortest. In more detail, (1) with respect to a feature point p, the image pair processing apparatus connects the feature point p and a feature point q when a horizontal distance between the feature points p and q is shortest. (2) With respect to the feature point p, the image pair processing apparatus connects the feature point p and the feature point q when a vertical distance between the feature points p and q is shortest. (3) With respect to the feature point p, the image pair processing apparatus connects the feature point p and the feature point q when a Euclidean distance between the feature points p and q is shortest. The connection graph generated by the image pair processing apparatus is a global graph corresponding to a 3-connected graph in which one feature point is connected to at least three other feature points including, for example, a feature point having a minimum horizontal distance, a feature point having a minimum vertical distance, and a feature point having a minimum Euclidean distance.

The image pair processing apparatus may generate a minimum tree including the feature points as nodes in the target region from the generated connection graph. Thus, the minimum tree may be generated for each target region of the frame image.

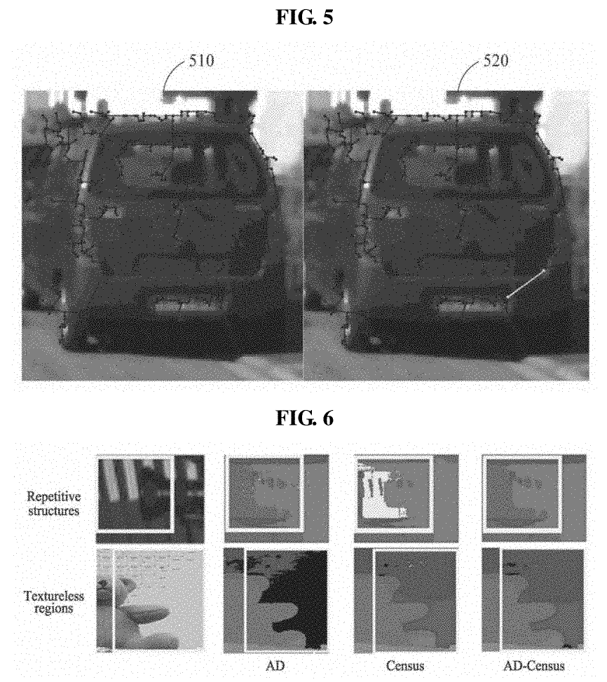

FIG. 5 illustrates an operation in which an image pair processing apparatus generates a minimum tree according to an example embodiment.

The image pair processing apparatus may determine a weight of each edge of a connection graph as a spatial distance between two feature points that are connected along an edge. The image pair processing apparatus may generate the minimum tree by connecting feature points based on the determined weight. The minimum tree includes an edge of which a sum of weights is a minimum value among all edges of the connection graph. The minimum tree may be a minimum spanning tree (MST) or a segment tree (ST). Referring to FIG. 5, the image pair processing apparatus generates a minimum tree from feature points of target regions 510 and 520. An MST as a minimum tree generated from the feature points by the image pair processing apparatus is represented in the target region 510. An ST as a minimum tree generated from the feature points by the image pair processing apparatus is represented in the target region 520.

For example, the image pair processing apparatus generates an MST based on a Prim's algorithm. In more detail, the image pair processing apparatus may select any one of the feature points as a root node, and add an edge having a weight that is the smallest, among edges of the feature point selected as the root node, to the minimum tree. The image pair processing apparatus may identify other feature points connected to the feature point selected as the root node based on the edge added to the minimum tree. The image pair processing apparatus may select the identified other feature points as leaf nodes corresponding to lower nodes of the root node. The image pair processing apparatus may add an edge having a weight that is the smallest (i.e., an edge having a weight that is the smallest among remaining edges excluding an edge added to a minimum tree) to the minimum tree among edges of the feature points selected as leaf nodes. The image pair processing apparatus may generate the MST that connects feature points from the feature point selected as the root node to all feature points by repeatedly performing the above-described operation with respect to the edge added to the minimum tree among edges of the leaf nodes.

The image pair processing apparatus may generate the minimum tree for a target region of each frame image included in an image pair. The image pair processing apparatus may generate a first minimum tree from a target region of a first frame image, and generate a second minimum tree from a target region of a second frame image. The image pair processing apparatus may accumulate costs measured from the feature points based on the generated first minimum tree and the generated second minimum tree.

In more detail, the image pair processing apparatus may determine costs for matching feature points of the first frame image and feature points of the second frame image based on a brightness and a disparity of each of the feature points of the first frame image and the corresponding feature points of the second frame image. The image pair processing apparatus may use a disparity range determined in advance when determining the costs. The image pair processing apparatus may determine a cost for each feature point corresponding to each node of a minimum tree.

The image pair processing apparatus may determine the costs for matching the feature points of the first frame image and the feature points of the second frame image based on a Birchfield and Tomasi (BT) cost or a Census cost. When the BT cost is determined, a linear interpolation may be used to reduce sensitivity occurring due to an image sampling effect. The Census cost may be determined based on a number of pixels having a brightness less than that of a current pixel by comparing the brightness of the current pixel to a brightness of a pixel neighboring the current pixel. Thus, the Census cost may have a feature robust against an illumination. The image pair processing apparatus may determine the costs for matching the feature points of the first frame image and the feature points of the second frame image by combining the BT cost and the Census cost using Equation 3.

C(p)=w×C_{BT}(P)+(1−w)×C_{Census}(p) [Equation 3]

As shown in Equation 3, C(p) denotes a cost for matching a pixel p, for example, a feature point, of the first frame image and a corresponding pixel of the second frame image. w denotes a weight between the BT cost and the Census cost. C_{BT}(p) denotes a BT cost for the pixel p, and C_{Census}(p) denotes a Census cost for the pixel p.

FIG. 6 illustrates a result of a comparison experiment on absolute intensity differences (AD), Census, and AD+Census. FIG. 6 illustrates a result of a Middlebury's comparison experiment on the AD, the Census, and the AD+Census.

The image pair processing apparatus may determine a matching cost vector indicating the costs for matching the feature points of the first frame image and the feature points of the second frame image from a cost C(p). A number of matching cost vectors may be identical to a number of disparities within the disparity range. As described above, a number of dimensions of a matching cost vector decreases and thus, an amount of operation may be reduced because the disparity range is determined to be a relatively small range including a disparity having a minimum brightness difference.

The image pair processing apparatus may determine the costs for matching feature points corresponding to respective nodes of the minimum tree, and then accumulate the costs determined for each node from a root node to a leaf node of the minimum tree. The image pair processing apparatus may accumulate costs of lower nodes (child nodes) of each node along a direction from the root node to the leaf node, from each node of the minimum tree. The image pair processing apparatus may accumulate costs of upper nodes (parent nodes) of each node along a direction from the leaf node to the root node, for each node of the minimum tree.

The image pair processing apparatus may determine an accumulation matching cost obtained by accumulating the costs determined for each node of the minimum tree based on a result of accumulating the costs of lower nodes of each node and a result of accumulating the costs of upper nodes of each node. In more detail, the image pair processing apparatus may determine the accumulation matching cost based on a filtering method of the minimum tree. When the image pair processing apparatus accumulates the costs of the lower nodes (child nodes) of each node of the minimum tree along the direction from the root node to the leaf node, the image pair processing apparatus may accumulate the costs of the lower nodes using Equation 4.

$${C}_{d}^{A ↑} ( p ) = {C}_{d} ( p ) + {\sum }_{q ∈ Ch ( p )}^{ } S ( p , q ) \cdot {C}_{d}^{A ↑} ( q ) \qquad [ Equation 4 ]$$

In Equation 4, C_{d}^{A↑}(p) denotes an accumulation cost subsequent to a change of a pixel p, that is, a feature point corresponding to a predetermined node of a minimum tree, and C_{d}(p) denotes an initial cost for the pixel p. Ch(p) denotes a set of all child nodes of a node corresponding to the pixel p. S(p, q) denotes a similarity between the pixel p and a pixel q, that is, a feature point corresponding to a lower node of a predetermined node of a minimum tree, included in a child node. D denotes a matching cost vector, and a number of dimensions of the matching cost vector may be identical to a number of disparities. The number of dimensions of a matching cost vector decreases and thus, an amount of operation may be reduced because the disparity range is determined to be a relatively small range including a disparity having a minimum brightness difference. The image pair processing apparatus may search for all lower nodes of the predetermined node of the minimum tree and then update the accumulation matching cost of the predetermined node using Equation 4.

When the image pair processing apparatus accumulates costs of upper nodes (parent nodes) of each node of the minimum tree along a direction from the leaf node to the root node, the image pair processing apparatus may accumulate the costs of the upper nodes using Equation 5.

C_{d}^{A}(p)=S(Pr(p),p)·C_{d}^{A}(Pr(p)+(1−S²(Pr(p),p)·C_{d}^{A↑}(p) [Equation 5]

In Equation 5, Pr(p) denotes a parent node of the node corresponding to the pixel p, that is, a feature point corresponding to a predetermined node of a minimum tree, S(Pr(p), p) denotes a similarity between the parent node and the node corresponding to the pixel p, C_{d}^{A}(Pr(p)) denotes a cost for matching feature points of the parent node of the node corresponding to the pixel p. As shown in Equation 5, a finally calculated cost C_{d}^{A}(p) may be determined by the parent node of the node corresponding to the pixel p.

The similarity S(p, q) between two feature points of Equation 4 and the similarity S(Pr(p), p) between the parent node and the node corresponding to the pixel p may be determined using Equation 6.

$$S ( p , q ) = exp ( - \frac{\vert I ( p ) - I ( q ) \vert}{{σ}_{S}} - \frac{sqrt ( \begin{matrix}{( {x}_{p} - {x}_{q} )}^{2} + \\ {( {y}_{p} - {y}_{q} )}^{2}\end{matrix} )}{{σ}_{r}} - penalty ) \qquad [ Equation 6 ]$$

As shown in Equation 6, I(p) denotes a brightness value of the pixel p, and I(q) denotes a brightness value of the pixel q. xₚ denotes horizontal coordinates (x-axial coordinates) of the pixel p, and x_{q} denotes horizontal coordinates (x-axial coordinates) of the pixel q. yₚ denotes vertical coordinates (y-axial coordinates) of the pixel p, and y_{q} denotes vertical coordinates (y-axial coordinates) of the pixel q. σₛ and σᵣ corresponding to fixed parameters may be adjusted by experiment.

The image pair processing apparatus may determine disparities, depths, or depth information of feature points corresponding to respective nodes of the minimum tree based on the disparity having the minimum accumulation matching cost. For example, the image pair processing apparatus may determine the disparity of each of the feature points based on a winner-takes-all method. The image pair processing apparatus may determine a disparity of a feature point using Equation 7.

$${f}_{p} = \begin{matrix}argmin {C}^{′} ( p , d ) \\ d ∈ D\end{matrix} \qquad [ Equation 7 ]$$

As shown in Equation 7, fₚ denotes a disparity of the pixel p, that is, a feature point corresponding to a predetermined node of a minimum tree with respect to a target region of a first frame image, and C′(p,d) denotes a cost for matching the pixel p of the first frame image when the disparity corresponds to d. D denotes a disparity range. The image pair processing apparatus may determine a distance between a subject and a stereo camera based on the determined disparity of the feature point. The image pair processing apparatus may determine the distance between the subject and the stereo camera, and then perform an alarm treatment or an operational treatment. For example, when the subject is any one of a vehicle, a traffic sign, a pedestrian, an obstacle, and a background, the operational treatment may be at least one of braking or redirecting of an object, for example, a vehicle, controlled by the image pair processing apparatus.

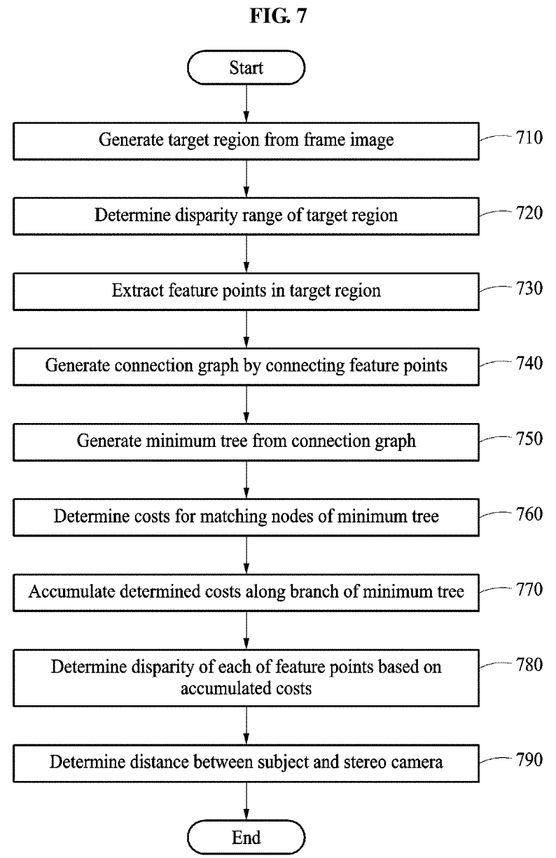

FIG. 7 is a flowchart illustrating an operation in which an image pair processing apparatus determines a distance between a stereo camera and a subject included in an image pair according to an example embodiment. A non-transitory computer-readable recording medium that stores a program to perform an image pair processing method may be provided. The program may include at least one of an application program, a device driver, firmware, middleware, a dynamic link library (DLL) or an applet storing the image pair processing method. The image pair processing apparatus includes a processor, and the processor reads a recording medium that stores the image pair processing method, to perform the image pair processing method.

Referring to FIG. 7, in operation 710, the image pair processing apparatus generates a target region from a frame image. The target region is a portion of the frame image, and includes a subject photographed by the stereo camera generating the frame image.

When the image pair processing apparatus receives a pair of a plurality of frame images generated from a plurality of image sensors included in the stereo camera, the image pair processing apparatus may generate a target region including a subject from each of the frame images. When the stereo camera includes two image sensors, the image pair processing apparatus receives a pair of a first frame image and a second frame image. The image pair processing apparatus may generate the target region including the subject from each of the first frame image and the second frame image of the image pair.

In operation 720, the image pair processing apparatus determines a disparity range of the target region. That is, the image pair processing apparatus may determine a range estimated to include a disparity associated with the subject included in the target region. The image pair processing apparatus may identify a target region extracted from any one frame image of the frame images and a corresponding region having a position, a shape, and a size identical to those of the target region from other frame images. The image pair processing apparatus may calculate a brightness difference between the target region and the corresponding region.

The image pair processing apparatus may calculate the brightness difference between the target region and the corresponding region from a plurality of corresponding regions. In more detail, the image pair processing apparatus may calculate the brightness difference between the target region and the corresponding region by horizontally moving the corresponding region in parallel at an height identical to that of the target region. That is, x-coordinates of the corresponding region are changed while y-coordinates are fixed.

The disparity range may be determined to include an amount of parallel movement (that is, disparity) of the corresponding region having the minimum brightness difference. For example, the image pair processing apparatus may determine the disparity range by applying the amount of parallel movement of the corresponding region having the minimum brightness difference to Equation 1 and Equation 2. Thus, the disparity range may be determined as a portion of an entire range in which the corresponding region is capable of moving in parallel.

In operation 730, the image pair processing apparatus extracts feature points in the target region. The image pair processing apparatus may extract the feature points from the target region of each of the frame images of the image pair.

In operation 740, the image pair processing apparatus generates a connection graph by connecting the extracted feature points. Nodes of the connection graph indicate feature points, and the nodes may be connected to each other based on a horizontal distance, a vertical distance, or a Euclidean distance between the feature points. The image pair processing apparatus may connect a predetermined feature point to other feature points between which a horizontal distance is shortest. The image pair processing apparatus may connect a predetermined feature point to other feature points between which a vertical distance is shortest. The image pair processing apparatus may connect a predetermined feature point to other feature points between which a Euclidean distance is shortest. The connection graph may be generated for each target region of each of the frame images.

In operation 750, the image pair processing apparatus generates a minimum tree from the generated connection graph. The minimum tree may be generated for each target region of each of the frame images corresponding to the connection graph, and all feature points included in the target region may be used as nodes. The image pair processing apparatus may determine a weight of each edge of the connection graph based on a spatial distance between two feature points that are connected along an edge. The image pair processing apparatus may select an edge of which a sum of weights is minimized, and generate the minimum tree based on the selected edge.

In operation 760, the image pair processing apparatus determines costs for matching the nodes of the minimum tree. That is, because the nodes correspond to the feature points, costs for matching the feature points may be determined from different frame images. The costs may be determined based on a brightness of the target region and the disparity range determined in operation 720. The image pair processing apparatus may determine the costs for matching the nodes of the minimum tree using Equation 3. According to an example embodiment, operation 720 may be simultaneously performed with at least one of operations 730 through 750. Also, operation 720 may be performed between operations 730 through 750.

In operation 770, the image pair processing apparatus accumulates the costs determined for each node of the minimum tree along a branch of the minimum tree. The image pair processing apparatus may search for the minimum tree along an upper direction or a lower direction of a predetermined node of the minimum tree. The image pair processing apparatus may accumulate the costs determined for each node by combining costs for matching nodes found in each direction with costs for matching predetermined nodes. For example, the image pair processing apparatus may accumulate the costs determined from each node along the branch of the minimum tree using Equation 4 or Equation 5.

In operation 780, the image pair processing apparatus determines a disparity of each of the feature points based on the accumulated costs. In more detail, the image pair processing apparatus may determine the disparity of each of the feature points corresponding to the predetermined nodes of the minimum tree based on a result of accumulating of the costs for matching the predetermined nodes and costs for matching other nodes connected with the predetermined nodes through the minimum tree.

In operation 790, the image pair processing apparatus determines a distance between a subject and a stereo camera based on the determined disparity of each of the feature points. When the distance between the subject and the stereo camera is determined, the image pair processing apparatus may determine a disparity of portion of pixels (feature points) of a target region instead of determining disparities of all pixels of the target region including the subject and thus, an amount of time and an amount of operation used to determine the distance and the stereo camera may be reduced. In addition, the image pair processing apparatus may determine the disparity of each of the feature points within the limited disparity range without measuring all disparities of feature points and thus, an amount of time or an amount of operation used to determine the disparity of each of feature points may be reduced. The image pair processing apparatus may perform an alarm treatment or an operational treatment based on the determined distance between the subject and the stereo camera.

Hereinafter, an example description of an experiment result of measuring distances between 280 subjects included in a Karlsruhe institute of technology and Toyota technological institute at Chicago (KITTI) dataset including a plurality of image pairs by the image pair processing apparatus based on a result of accumulating costs for matching each node of the minimum tree generated from the image pair, is provided. A subject includes a vehicle, a traffic sign, and a pedestrian. Table 1 represents an accuracy and an amount of time used to determine the distance between the subject and the stereo camera without accumulating the costs for the accuracy and the amount of time when the distance between the subject and the stereo camera is determined based on a result of accumulating the costs for matching the feature points using a minimum spanning tree (MST) or a segment tree (ST).

TABLE 1

| Dataset | Method | Accuracy | Time |
|---|---|---|---|
| KITTI | matching frame images without | 80.41% | 3.7 ms |
| (including 280 | accumulating costs | | |
| subjects) | matching frame images using | 90.25% | 4.53 ms |
| | minimum spanning tree (MST) | | |
| | matching frame images using | 90.39% | 4.65 ms |
| | segment tree (ST) | | |

Referring to Table 1, the accuracy in the distance between the subject and the stereo camera measured by the image pair processing apparatus corresponds to 90%, and the accuracy increases by 10% more than when the distance between the subject and the stereo camera is measured by matching the frame images without accumulating the costs.

Further, the image pair processing apparatus may track a position of the subject commonly included in the image pairs that are obtained sequentially as time elapses.

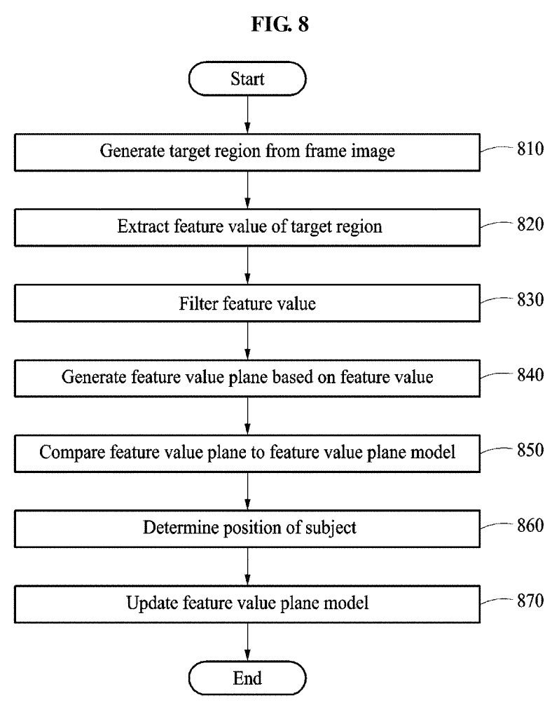

FIG. 8 is a flowchart illustrating an operation in which an image pair processing apparatus tracks a position of a subject commonly included in a plurality of image pairs according to an example embodiment.

In operation 810, the image pair processing apparatus generates a target region from a current frame image that is lastly input. An operation of generating the target region by the image pair processing apparatus may be similar to operation 710. The target region includes a subject to be tracked by the image pair processing apparatus.

In operation 820, the image pair processing apparatus extracts a feature value of the generated target region. In operation 830, the image pair processing apparatus filters the feature value of the target region of the current frame image. In operation 840, the image pair processing apparatus generates a feature value plane corresponding to the current frame image by interpolating the filtered feature value.

In operation 850, the image pair processing apparatus compares the generated feature value plane to a feature value plane model generated from a frame image obtained previous to the current frame. The feature value plane model may be updated or trained by at least one frame image obtained previous to the current frame image. In more detail, the image pair processing apparatus may fit the generated feature value plane to the feature value plane model. The image pair processing apparatus may calculate a response value when the feature value plane is fitted to the feature value plane model.

In operation 860, the image pair processing apparatus determines a position of the subject in the current frame image based on a result of comparing of the feature value plane to the feature value plane model. In more detail, the image pair processing apparatus may determine a position having a maximum response value as the position of the subject. In operation 870, the image pair processing apparatus updates the feature value plane model based on the position of the subject in the current frame image.

The image pair processing apparatus may determine the position of the subject in a subpixel standard. The image pair processing apparatus may provide an accuracy in the subpixel standard based on a plane interpolation fitting method.

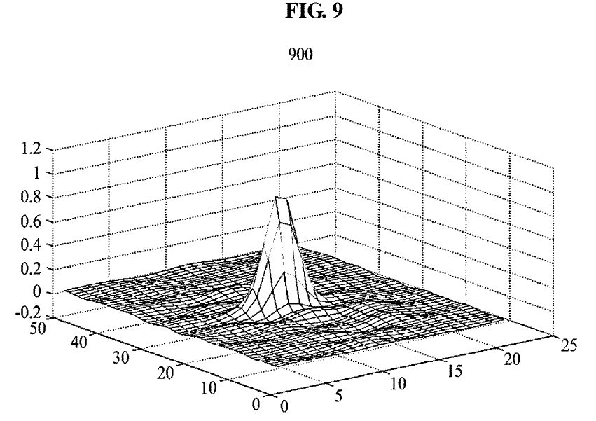

FIG. 9 is a graph 900 illustrating a distribution of response values calculated by fitting a feature value plane to a feature value plane model by an image pair processing apparatus according to an example embodiment. The response values may be determined based on a response function R(x,y)=ax²+by²+cxy+dx+ey+f. Referring to the graph 900, a maximum value among the response values corresponds to a position of a subject in a current frame image. Coordinates (x*, y*) having a maximum response value may be determined based on a partial differential function

$$\frac{\partial R ( x , y )}{\partial x} = 0 , \\ \frac{\partial R ( x , y )}{\partial y} = 0$$

of a response function R(x,y) as shown in Equation 8.

$$x *= \frac{2 bd - ce}{{c}^{2} - 4 ab} \\ y *= \frac{2 ae - cd}{{c}^{2} - 4 ab} \qquad [ Equation 8 ]$$

Six parameters, a through f, of the response function R(x,y) may be determined based on an overdetermined equation. In more detail, the image pair processing apparatus may obtain six equations based on response values of six points close to the coordinates (x*, y*) having the maximum response value. The image pair processing apparatus may determine the parameters a through f using equations obtained based on a method of substitution and a method of elimination.

Hereinafter, an example description of a test result of determining the position of the subject from nine video images selected from a public dataset OOTB by the image pair processing apparatus is provided. The selected nine video images include sequences FaceOcc1, Coke, David, Bolt, Car4, Suv, Sylvester, Walking2, and Singer2. An accuracy in tracking of the subject by the image pair processing apparatus is represented in Table 2.

TABLE 2

| | Sequence | | | | | | | | |
|---|---|---|---|---|---|---|---|---|---|
| | FaceOcc1 | Coke | David | Bolt | Car4 | Suv | Sylvester | Walking2 | Singer2 |
| Kernelized | 0.730 | 0.838 | 1.0 | 0.989 | 0.950 | 0.979 | 0.843 | 0.440 | 0.945 |
| correlation | | | | | | | | | |
| filter | | | | | | | | | |
| (KCF) | | | | | | | | | |
| Subpixel | 0.754 | 0.873 | 1.0 | 0.997 | 0.953 | 0.980 | 0.851 | 0.438 | 0.962 |
| KCF | | | | | | | | | |

Referring to Table 2, an accuracy in tracking of the position of subject by the image pair processing apparatus is enhanced more than when the related subject position tracking method is used.

Thus, the image pair processing apparatus extracts feature points from each target region being smaller than a received frame image such that an amount of time or an amount of operation used to extract the feature points may be reduced. Also, the image pair processing apparatus matches feature points and measures a disparity of each of the feature points as a portion of the target region such that an amount of time or an amount of operation used to process the frame images may be reduced. When the image pair processing apparatus determines a minimum accumulation matching cost for nodes of a minimum tree, the image pair processing apparatus may filter and remove accumulated matching costs such that an amount of operation used to determine the disparity of each of the feature points may be reduced.

In addition, because the extracted feature points include a feature of a subject, an accuracy in a distance between the subject and the stereo camera determined based on the feature points may be enhanced. Thus, when the distance between the subject and the stereo camera is measured with the same accuracy, the image pair processing apparatus may enhance a speed for processing the image pair by reducing an amount of operation of an entire process for processing the image pair.

The image pair processing apparatus may decrease a disparity range used to match feature points of a target region by determining the disparity range with respect to the target region. In more detail, a number of matching cost vectors calculated by the image pair processing apparatus decreases by a number of disparities within the disparity range and thus, an amount of operation used to determine costs for matching the feature points and accumulate the determined costs may be reduced.

The image pair processing apparatus may generate a connection graph including a plurality of feature points as nodes based on the feature points in a target region. Further, the image pair processing apparatus may decrease a number of edges included in the connection graph while maintaining all feature points as nodes by generating a minimum tree from the connection graph.

The image pair processing apparatus may extract feature values of a target region of a current frame image, and then generate a feature value plane of the current fame image by interpolating the extracted feature values. The image pair processing apparatus may determine a position of a subject in the current frame image by comparing the generated feature value plane to a feature value plane model generated from a frame image obtained previous to the current frame image. Thus, the image pair processing apparatus may more accurately determine the position of subject in the current frame image.

According to an example embodiment, units and/or modules described herein may be implemented using hardware components and software components. For example, the hardware components may include amplifiers, band-pass filters, audio to digital converters, and processing devices. According to an another example embodiment, the image pair processing apparatus 100 may be implemented using hardware components and/or software components. A processing device may be implemented using one or more hardware devices configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

According to an example embodiment, software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

According to an example embodiment, the methods according to the above-described example embodiments may be recorded in non-transitory computer-readable media including program instructions to implement various operations of the above-described example embodiments. According to an example embodiment, a non-transitory computer readable medium storing a program instructions for performing the method of FIG. 7 or 8 above may be provided. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of image processing, the method comprising:
generating a target region, including a subject, for each of a first frame image and a second frame image, among an image pair obtained by an image capturing device; extracting first feature points in the target region of the first frame image and second feature points in the target region of the second frame image;
determining disparity information by matching the first feature points extracted from the first frame image and the second feature points extracted from the second frame image; and
determining a distance between the subject and the image capturing device based on the disparity information.

2. The method of claim 1, wherein the determining the disparity information comprises:
generating a first tree including the first feature points of the first frame image as first nodes by connecting the first feature points of the first frame image based on a horizontal distance, a vertical distance, and a Euclidean distance between the first feature points of the first frame image;
generating a second tree including the second feature points of the second frame image as second nodes by connecting the second feature points of the second frame image based on a horizontal distance, a vertical distance, and a Euclidean distance between the second feature points of the second frame image; and
matching the first nodes of the first tree and the second nodes of the second tree to determine the disparity information of each of the first feature points of the first frame image and each of the second feature points of the second frame image.

3. The method of claim 2, wherein the matching comprises:
accumulating costs for matching the first nodes of the first tree and the second nodes of the second tree along upper nodes of the first nodes of the first tree or lower nodes of the first nodes of the first tree; and
determining a disparity of each of the first feature points of the first frame image and each of the second feature points of the second frame image based on the accumulated costs, and
wherein the costs are determined based on a brightness and a disparity of a node of the first tree and a brightness and a disparity of a node of the second tree to be matched.

4. The method of claim 1, further comprising determining a disparity range associated with the subject based on a brightness difference between the target region of the first frame image and the target region of the second frame image determined based on a position of the target region of the first frame image.

5. The method of claim 4, wherein the determining the disparity information comprises matching the first feature points extracted from the first frame image and the second feature points extracted from the second frame image within the determined disparity range.

6. The method of claim 4, wherein the determining the disparity range comprises:
moving the target region of the second frame image in parallel; and
comparing a brightness of the target region of the second frame image moved in parallel to a brightness of the target region of the first frame image.

7. The method of claim 1, further comprising:
extracting a feature value of the target region corresponding to the first frame image;
generating a feature value plane of the first frame image based on the extracted feature value;
comparing the feature value plane to a feature value plane model generated from a feature value plane of previous frame image obtained previous to the first frame image; and
determining a position of the subject from the first frame image based on a result of the comparing of the feature value plane to the feature value plane model.

8. The method of claim 7, further comprising changing the feature value plane model based on the determined position of the subject.

9. An image processing apparatus comprising:
a memory configured to store an image pair obtained by an image capturing device; and
a processor configured to:
generate a target region, including the subject, for each of a first frame image and a second frame image, among the image pair; extract first feature points in the target region of the first frame image and second feature points in the target region of the second frame image;
determine disparity information by matching the first feature points extracted from the first frame image and the second feature points extracted from the second frame image; and
determine a distance between the subject and the image capturing device based on the disparity information.

10. The image processing apparatus of claim 9, wherein the processor is further configured to determine the disparity information based on costs for matching a first tree including the first feature points of the first frame image as first nodes and a second tree including the second feature points of the second frame image as second nodes.

11. The image processing apparatus of claim 10, wherein the processor is further configured to determine the costs based on a similarity determined based on a brightness and a disparity of a feature point corresponding to a node of the first tree and a brightness and a disparity of a feature point corresponding to a node of the second tree.

12. The image processing apparatus of claim 10, wherein each of the first tree and the second tree is generated by connecting the first feature points of the first frame image between which a spatial distance is smallest and the second feature points of the second frame image between which a spatial distance is smallest.

13. The image processing apparatus of claim 9, wherein the processor is further configured to determine a disparity range associated with the subject based on a brightness difference between the target region of the first frame image and the target region of the second frame image determined based on a position of the target region of the first frame image.

14. The image processing apparatus of claim 13, wherein the processor is further configured to match the first feature points extracted from the first frame image and the second feature points extracted from the second frame image within the determined disparity range.

15. The image processing apparatus of claim 9, wherein the processor is further configured to:
extract a feature value of the target region corresponding to the first frame image;
generate a feature value plane of the first frame image based on the extracted feature value;
compare the feature value plane to a feature value plane model generated from a feature value plane of a previous frame image obtained previous to the first frame image; and
determine a position of the subject from the first frame image based on a result of the comparing of the feature value plane to the feature value plane model.

16. A non-transitory computer readable medium having stored thereon a program for executing a method of image processing comprising:
generating a target region, including a subject, for each of a first frame image and a second frame image, among an image pair obtained by an image capturing device;
extracting first feature points in the target region of the first frame image and second feature points in the target region of the second frame image;
determining disparity information by matching the first feature points extracted from the first frame image and the second feature points extracted from the second frame image; and
determining a distance between the subject and the image capturing device based on the disparity information.
